(19) United States
(12) Patent Application Publication
(10) Pub. No.: US 2011/0198843 A1
(43) Pub. Date: Aug. 18, 2011

(54) PORT STRUCTURE AND FLUID DEVICE INCLUDING THE PORT STRUCTURE

(75) Inventors: Shinji IKENOYA, Tajimi-shi (JP); Kiyoshi NAGAI, Tajimi-shi (JP)

(73) Assignee: CKD CORPORATION, KOMAKI-SHI (JP)

(21) Appl. No.: 13/007,138

(22) Filed: Jan. 14, 2011

(30) Foreign Application Priority Data
Feb. 18, 2010 (JP) 2010-034108

(51) Int. Cl. F16L 19/00

(52) U.S. Cl. 285/355

(57) ABSTRACT

A port structure for connecting a resin tube to a port part includes a tube insertion hole in which the tube is inserted, a female screw portion provided in an opening of the tube insertion hole, and a tapered hole provided on a inward side of the female screw portion and formed with a taper with a diameter decreasing from the female screw side to the rear end. When a nut is screwed into the female screw portion to press the ferrule against the tapered hole, a repulsive force of the tapered hole acts on a tapered surface of the ferrule, elastically deforming the ferrule radially inward so that the ferrule bites into the tube and is pressed against the tapered hole to provide a seal.

### CROSS-REFERENCE TO RELATED APPLICATIONS

This application is based upon and claims the benefit of priority from the prior Japanese Patent Application No. 2010-034108, filed on Feb. 18, 2010, the entire contents of which are incorporated herein by reference.

### TECHNICAL FIELD

The present invention relates to a port structure for connecting a resin tube to a resin port part through which a fluid flows in or out, and a fluid device including the port structure.

### BACKGROUND ART

For instance, a semiconductor manufacturing device includes a pipe arrangement for delivering air to be used for control of actuation of a valve, gas replacement, and others. In the pipe arrangement, there are placed various fluid devices (valves, pumps, sensors such as a pressure sensor and a flow sensor, fluid control devices such as a mass flow controller and a regulator, cylinders, and joints) to control the flow rate and the pressure of air and change a direction of a flow passage.

For instance, a valve 101 shown in FIG. 17 includes a valve part 102 and an actuator part 103 connected thereto, forming an outer configuration of the valve 101. In the actuator part 103, a tube 111 is connected to an operation port part 104 through a joint 112 and a tube 121 is connected to an air discharge port part 105 through a joint 122. A port structure for connecting the tube 111 to the operation port part 104 is identical to a port structure for connecting the tube 121 to the air discharge port part 105. Thus, the following explanation is given to only the port structure for connecting the tube 11 to the operation port part 104.

As shown in FIG. 18, the joint 112 is configured such that a screw body 113 is attached to an open end of a joint body 114 and a collet ring 116 is slidably attached to the other open end of the joint body 114 through a tapered ring 115. The joint 112 is attached to the operation port part 104 in such a manner that a male screw 117 formed on the screw body 113 is screwed into a tapered female screw portion 104a formed in an inner peripheral surface of the operation port part 104. The collet ring 116 has a leading end circumferentially divided into a plurality of claws 118 each being elastically deformable. When the collet ring 116 is pushed in the joint body 114, the claws 118 expand outward along a tapered inner surface of the tapered ring 115, increasing the inner diameter of the collet ring 116. The tube 111 is inserted into the joint body 114 through the collet ring 116 in such a state. Then, when internal pressure is applied to the tube 111, moving the tube 111 in a direction to separate from the operation port part 104, the claws 118 are elastically deformed inward along the tapered surface of the tapered ring 115 and bite into the outer peripheral surface of the tube 111. In this way, the tube 111 is connected to the joint 112 and thus held against detachment (see Patent Literature 1 for example).

Further, there is also a port structure shown in FIGS. 19A and 19B, for example, in which an instant joint 202 attached with a seal member 203 is inserted in an operation port part 201, and the instant joint 202 is fixed to an operation port part 201 by use of a fixing member 204. In this port structure, attachment/detachment of the fixing member 204 enables easy connection of the instant joint 202 to the operation port part 201 for installation of pipe arrangement (see Patent Literature 2 for example).

### CITATION LIST

### Patent Literature

### Patent Literature 1: JP 3386406 B

### Patent Literature 2: JP 2006-52821 A

### SUMMARY OF INVENTION

### Technical Problem

However, the conventional port structure shown in FIG. 18 has the following disadvantage. When the joint 112 is to be assembled, a seal tape is first wound around the male screw 117 or the tapered female screw portion 104a to prevent fluid leakage and then the male screw 117 is screwed into the female screw portion 104a. This joint connecting work would take long.

The present invention has been made to solve the above problems and has a purpose to provide a port structure capable of performing a tube connecting work to connect a tube to a port part in short time, and a fluid device including the port structure.

### Solution to Problem

To achieve the above purpose, one aspect of the invention provides a port structure for connecting a resin tube to a port part through which a fluid flows in or out, wherein the port part includes: a tube insertion hole in which a tube is to be inserted; a female screw portion provided in an opening of the port part; and a tapered hole provided on a inward side of the female screw portion and defined by an inner wall surface having a taper with a diameter decreasing from the female screw side to an inward side of the port part, the port structure comprises: a nut formed with a through hole in which the tube is inserted and a male screw engaging with the female screw, and a ferrule made of an elastically deformable material in an annular shape and formed with an outer surface including a tapered surface with a diameter decreasing from a rear end to a front end, wherein the nut is screwed into the female screw portion to press the ferrule against the inner wall surface of the tapered hole so that the ferrule is elastically deformed radially inward by a repulsive force generated in the inner wall surface of the tapered hole and is pressed against the inner wall surface of the tapered hole to provide a seal.

According to another aspect of the invention provides a fluid device placed in a flow path for flowing a fluid, comprising a port structure including: a port part to which a resin tube is connected to allow air or inert gas to flow in or out, the port part including: a tube insertion hole in which a tube is to be inserted; a female screw portion provided in an opening of the port part; and a tapered hole provided between the tube insertion hole and the female screw portion and defined by an inner wall surface having a taper with a diameter decreasing from the female screw side toward the tube insertion hole side, a nut formed with a through hole in which the tube is to be inserted and a male screw engaging with the female screw portion; and a ferrule made of an elastically deformable material in an annular form and formed with an outer surface including a tapered surface with a diameter decreasing a rear end to a front end, wherein the nut is screwed into the female screw portion to press the ferrule against the inner wall surface of the tapered hole so that the ferrule is elastically deformed radially inward by a repulsive force generated in the inner wall surface of the tapered hole and is pressed against the inner wall surface of the tapered hole to provide a seal.

The fluid device may include valves, pumps, sensors, fluid control devices, joints, and cylinders.

### Advantageous Effects of Invention

According to the above aspect of the invention, the ferrule is attached to the tapered hole of the port part, the nut is lightly screwed in the female screw, and then the tube is inserted in the tube insertion hole through the through hole of the nut and the ferrule. When the nut is further tightened, the ferrule is pressed against the inner wall of the tapered hole. The ferrule is thus elastically deformed inward by repulsive force applied on the tapered surface from the inner wall of the tapered hole. Thereby, the ferrule holds the tube. The ferrule is also pressed against the inner wall of the tapered hole to seal against fluid leakage. Accordingly, the above aspect in which the ferrule is placed in the port part, thereby simultaneously enabling both connecting of the tube to the port part and sealing of the tube connected portions by simply screwing the male screw of the nut into the female screw portion of the port part. This can omit a work for winding a seal tape around the female screw portion of the port part or the male screw of the nut before the nut is screwed into the port part. Consequently, a tube connecting work to connect the tube to the port part can be performed in short time.

### BRIEF DESCRIPTION OF DRAWINGS

FIG. 1 is a cross sectional view of a port structure in a first embodiment of the present invention;

FIG. 2 is an exploded view of the port structure of FIG. 1;

FIG. 3 is a perspective view of a ferrule in the first embodiment;

FIG. 4 shows a state of the port structure of FIG. 1 before tube connection;

FIG. 5 is a front view of a valve (a fluid device) including the port structure of FIG. 1;

FIG. 6 is a cross sectional view of a port structure in a second embodiment of the invention;

FIG. 7 shows a state of the port structure of FIG. 6 before tube connection;

FIG. 8 is a cross sectional view of a port structure in a third embodiment of the present invention;

FIG. 9 shows a state of the port structure of FIG. 8 before tube connection;

FIG. 10 is a cross sectional view of a port structure in a fourth embodiment of the present invention;

FIG. 11 shows a state of the port structure of FIG. 10 before tube connection;

FIG. 12 is a cross sectional view of a port structure in a fifth embodiment of the present invention;

FIG. 13 is a cross sectional view of a port structure in a sixth embodiment of the present invention;

FIG. 14 shows a state of the port structure of FIG. 13 before tube connection;

FIG. 15 is a view of a modified example of a fluid device of the present invention;

FIG. 16 is an external perspective view of a nut;

FIG. 17 is a front view of a conventional valve;

FIG. 18 is a cross sectional view of a conventional port structure; and

FIGS. 19A and 19B are perspective views of a conventional instant port structure.

### DESCRIPTION OF EMBODIMENTS

A detailed description of a preferred embodiment of the present invention will now be given referring to the accompanying drawings.

### First Embodiment

### Valve Applied with a Port Structure

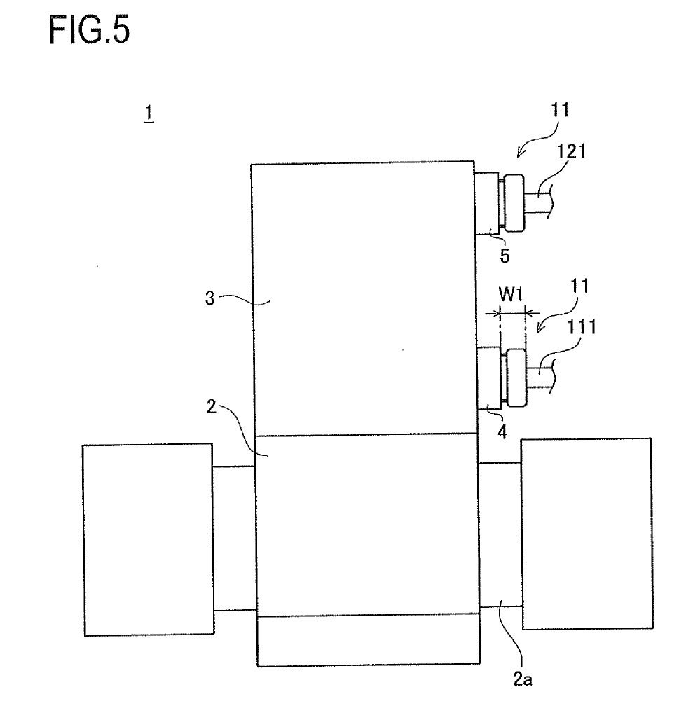

FIG. 5 is a front view of a valve 1 including a port structure 11 of the present embodiment. The valve (one example of a fluid device) 1 has an outer appearance including a valve part 2 and an actuator part 3 assembled together. The valve 1 is constructed of components made of high anticorrosion resin such as fluorocarbon resin, except for components such as a spring that needs to be made of metal or rubber for functionality. The actuator part 3 includes a first operation port part 4 (one example of a port part) and a second operation port part 5 (another example of the port part) each being applied with the port structure 11, to which resin tubes 111 and 121 are connected respectively. The valve 1 is opened by supply of operation air through the first operation port part 4 and closed by supply of operation air through the second operation port part 5.

<Port Structure>

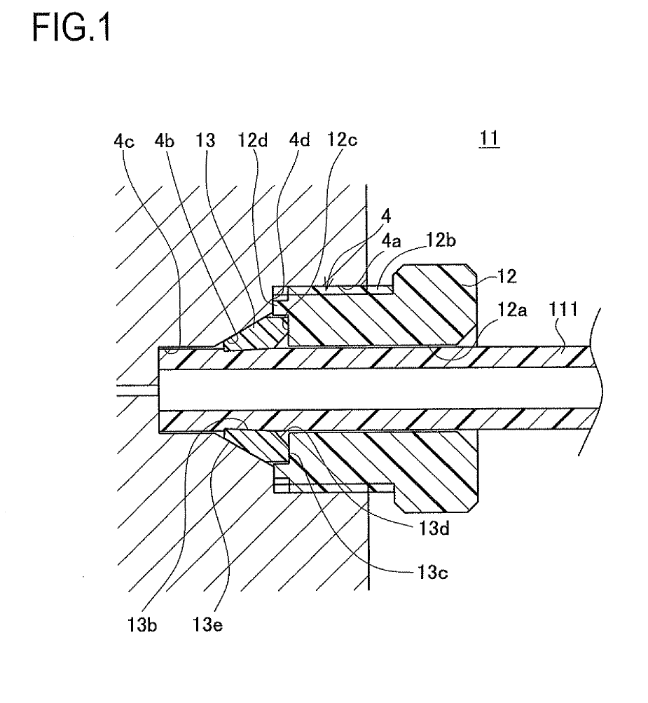

The port structure 11 in the first operation port part 4 is identical to that in the second operation port part 5. Thus, the following explanation is given with a focus on the port structure 11 in the first operation port part 4. FIG. 1 is a cross sectional view of the port structure 11. The port structure 11 is configured to connect the tube 111 to the first operation port part 4 by use of a ferrule 13 and the nut 12 attached to the first operation port part 4.

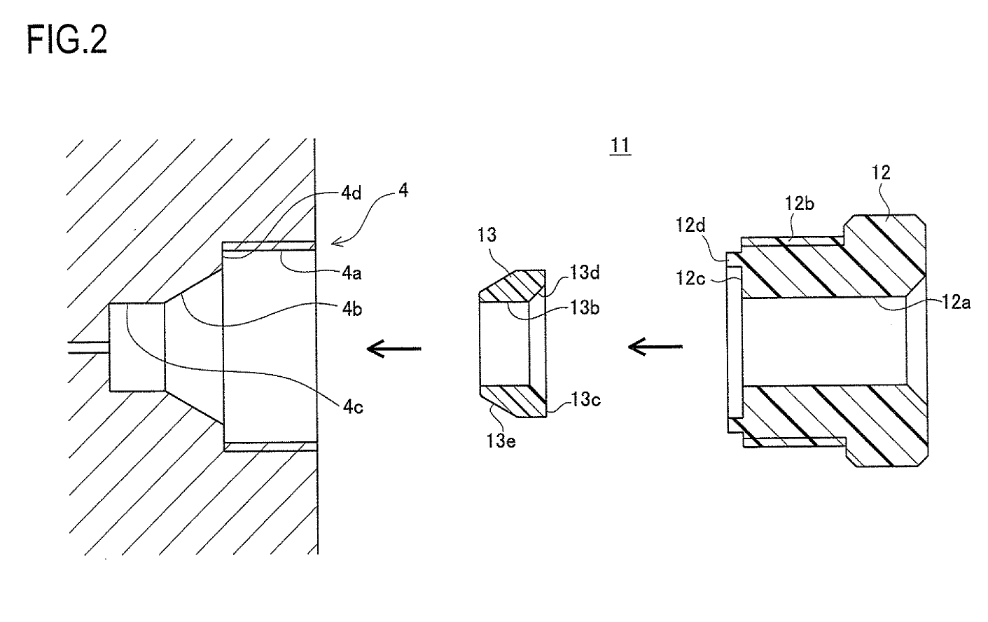

FIG. 2 is an exploded view of the port structure 11 of FIG. 1. The first operation port part 4 is formed with a tube insertion hole 4c for receiving the tube 111. A female screw portion 4a is formed in an opening of the port part 4. On an inward side (on the left side in the figure) of the female screw portion 4a, a tapered hole 4b is formed coaxial with the tube insertion hole 4c for receiving the ferrule 13. The tapered hole 4b is defined by a tapered inner wall surface having a decreasing diameter from the female screw portion 4a side to the inward side of the first operation port part 4 to thereby apply an inward force to the ferrule 13. The port part 4 is further formed with a flat surface perpendicular to an inserting direction of the nut 12 is formed between the tapered hole 4b and the female screw portion 4a, thereby forming a shoulder surface 4d.

The nut 12 is internally formed with a through hole 12a axially extending for passing the tube 111 and has an outer peripheral surface formed with a male screw 12b that threadedly engages the female screw portion 4a of the first operation port part 4. A front end face 12c of the nut 12 is formed with an annular protrusion 12d for limiting a screwing amount (one example of a screwing-amount limiting portion). This protrusion 12d abuts against the shoulder surface 4d to control the screwing amount of the nut 12 into the port part 4.

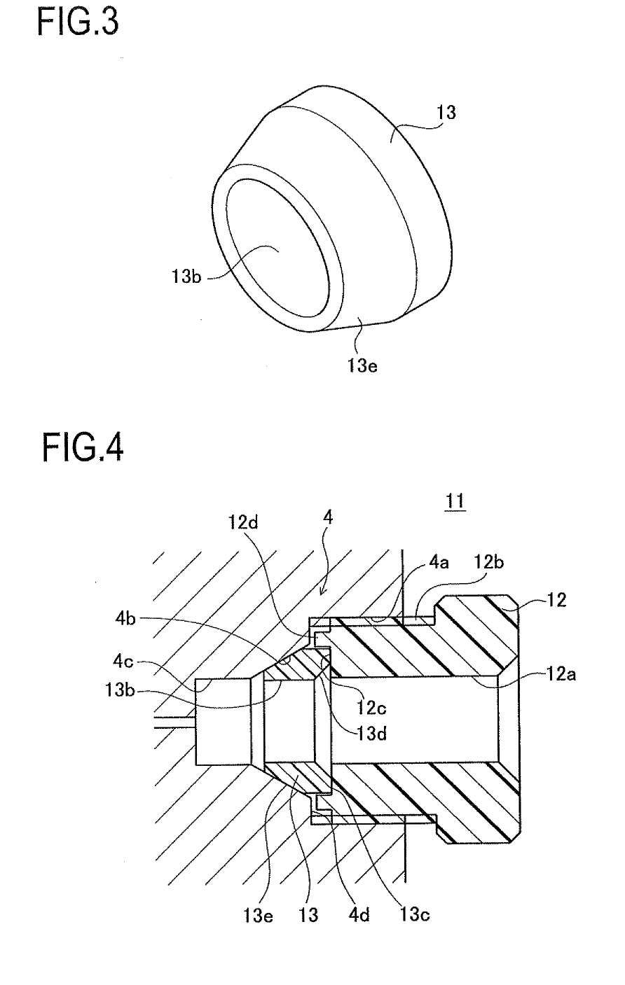

FIG. 3 is a perspective view of the ferrule 13. This ferrule 13 is made of a softer material (e.g., fluorocarbon resin, rubber, etc.) than materials forming the inner wall of the first operation port part 4 and the nut 12 in order to produce a sealing force when the ferrule 13 is pressed against the tapered hole 4b. In the present embodiment, the ferrule 13 is made of PTFE (polytetrafluoroethylene) to improve slip with respect to the nut 12 in addition to the sealing force. The ferrule 13 is formed with an axially extending through hole 13b for passing the tube 111 as shown in FIGS. 2 and 3. The ferrule 13 is formed, on its outer periphery, with a tapered surface 13e having a diameter decreasing from a rear end to a front end of the ferrule 13 in correspondence with the slope of the tapered hole 4b. Thus, a force from the inner wall of the tapered hole 4b on the tapered surface 13e causes a radially inward force to act on the front end portion of the ferrule 13. With this tapered surface 13e, the ferrule 13 is thinner in wall thickness toward the front end. The front end of the ferrule 13 is therefore easily deformable.

The ferrule 13 is pressed against the inner wall of the tapered hole 4b to seal against fluid leakage. The ferrule 13 is formed, on an inner peripheral surface of a rear end portion of the through hole 13b, with a guide portion 13d having a tapered surface increasing in diameter toward a pressure-receiving surface 13e side to guide the tube 111 into the through hole 13b.

<Method of Attaching/Detaching a Tube>

FIG. 4 shows a state of the port structure 11 of FIG. 1 before tube connection. The ferrule 13 and the nut 12 are mounted in the first operation port part 4 and the second operation port part 5 respectively prior to shipment of the valve 1. Specifically, the ferrule 13 is fitted in the annular protrusion 12d of the nut 12 and then the nut 12 is screwed into the female screw portion 4a of the first operation port part 4, thereby attaching the ferrule 13 and the nut 12 to the first operation port part 4. In this case, the ferrule 13 is engaged in the protrusion 12d and less likely to drop off and thus assembly is easy. It is to be noted that at this time the nut 12 is merely lightly screwed into the operation port part 4 so as not to press the ferrule 13.

When the valve 1 is installed in a pipe arrangement at a customer's site, the tubes 111 and 121 are connected to the first operation port part 4 and the second operation port part 5 respectively. In this case, for instance, the tube 111 is inserted in the tube insertion hole 4c of the first operation port part 4 through the through hole 12a of the nut 12 and the through hole 13b of the ferrule 13. Then, the male screw 12b of the nut 12 is gradually tightened into the female screw portion 4a of the first operation port part 4. By thrust of the screw in a feeding motion, the front end face 12c of the nut 12 presses against the pressure-receiving surface 13c of the ferrule 13. The ferrule 13 is pushed into the tapered hole 4b while causing the tapered surface 13e to slide in contact with the inner wall of the tapered hole 4b. The front end portion of the ferrule 13 is therefore decreased in inner diameter and hence bites into the tube 111. Since the ferrule 13 is held against movement in an axial direction between the tapered hole 4b and the nut 12, the tube 111 is snagged by the front end portion of the ferrule 13 and hence does not come off from the first operation port part 4 even when the ferrule 13 is subjected to a force in a direction to separate from the first operation port part 4.

When the protrusion 12d abuts against the shoulder surface 4d, the rotational torque of the nut 12 suddenly rises. Accordingly, a user can easily perceive an appropriate screwing amount of the nut 12 from a change in operational feeling to rotate the nut 12. When the protrusion 12d abuts against the shoulder surface 4d, the nut 12 is not allowed to further move toward the tapered hole 4b and screw into the female screw portion 4a any more. Consequently, the port structure 11 anytime enables the nut 12 to be screwed by an appropriate amount into the female screw portion 4a, thereby preventing defects such as breakage of a screw portion due to excessive rotation of the nut 12.

As mentioned above, the ferrule 13 is pressed and deformed between the inner wall of the tapered hole 4b and the front end face 12c of the nut 12 and thus pressed against the inner wall of the tapered hole 4b, thereby providing a seal to prevent fluid leakage from the first operation port part 4.

For instance, when the tube 111 is to be detached from the first operation port part 4 for valve maintenance and replacement, the nut 12 is loosened. Thus the ferrule 13 is released from a pressed state between the nut 12 and the tapered hole 4b. The ferrule 13 then presses against the inner wall of the tapered hole 4b outward by the elasticity of the ferrule 13 and the elasticity of the tube 111. In this state, the tapered surface 13e of the ferrule 13 receives a repulsive force from the inner wall of the tapered hole 4b increasing in diameter toward the female screw portion 4a. The ferrule 13 is therefore pushed toward female screw portion 4a. In association with the movement of the ferrule 13, the radially inward force acting on the ferrule 13 is relaxed. This makes the front end portion of the ferrule 13 disengage from the tube 111. When the tube 111 is then pulled in a direction to separate from the first operation port part 4, the tube 111 is disconnected from the ferrule 13, the nut 12, and the first operation port part 4.

If the ferrule 13 deteriorates, the nut 12 is demounted, the ferrule 13 is replaced with a new one, and they are attached to the first operation port part 4 in the same manner as at the time of shipment. Thus, the tube 111 is attached to the first operation port part 4 again in the same manner as the aforementioned tube attaching method.

<Advantages>

According to the port structure 11 and the valve 1 in the first embodiment, the ferrule 13 is mounted in the tapered hole 4b of the first operation port part 4 and the nut 12 is lightly screwed into the female screw portion 4a, and then the tube 111 is inserted in the tube insertion hole 4c through the through hole 12a of the nut 12 and the ferrule 13. Thereafter, the nut 12 is tightly screwed into the female screw portion 4a so that the ferrule 13 is pressed against the inner wall of the tapered hole 4b. Upon receipt of the repulsive force from the tapered hole 4b on the tapered surface 13e, the ferrule 13 is elastically deformed, holding the tube 111. Further, the ferrule 13 is pressed against the inner wall of the tapered hole 4b and thus provides a seal against fluid leakage. As above, according to the port structure 11 and the valve 1 in the present embodiment, it is only necessary to place the ferrule 13 in the tapered hole 4b of the operation port part 4 and simply screw the nut 12 into the female screw portion 4a, the tube 111 can be connected to the first operation port part 4 and also the tube connecting portion can be sealed. This can eliminate a work for winding a seal tape around the female screw portion 4a of the first operation port part 4 or the male screw of the nut 12 before the nut 12 is screwed into the first operation port part 4. Therefore, a tube connecting work for connecting the tube 111 to the first operation port part 4 can be performed in short time.

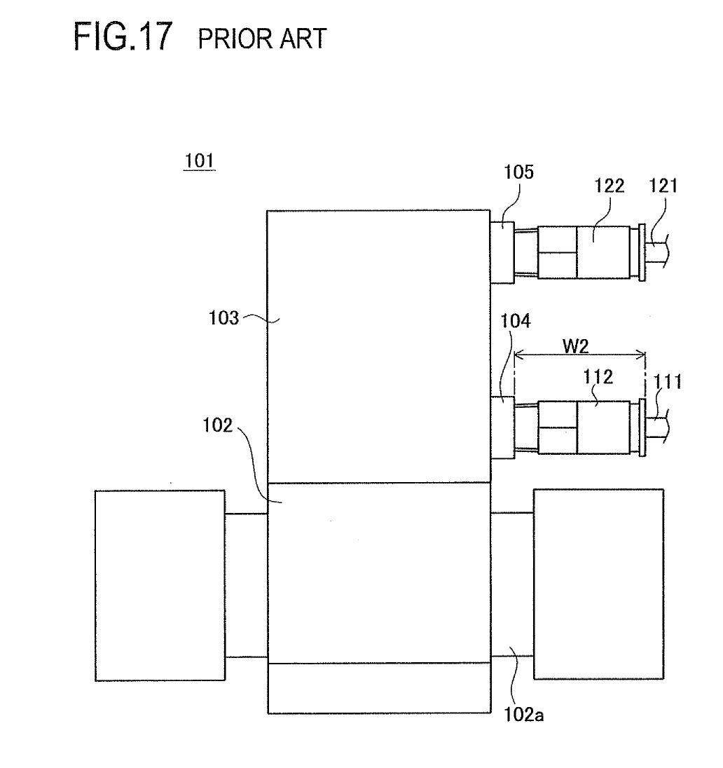

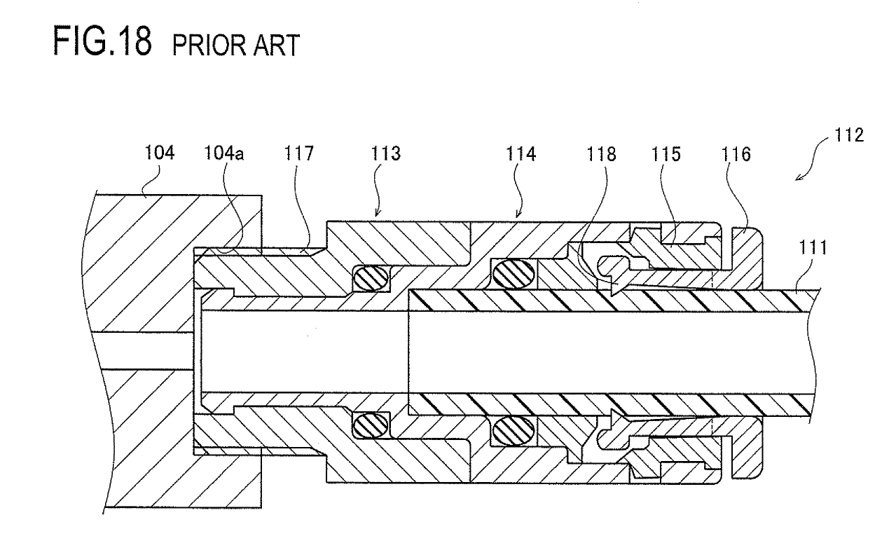

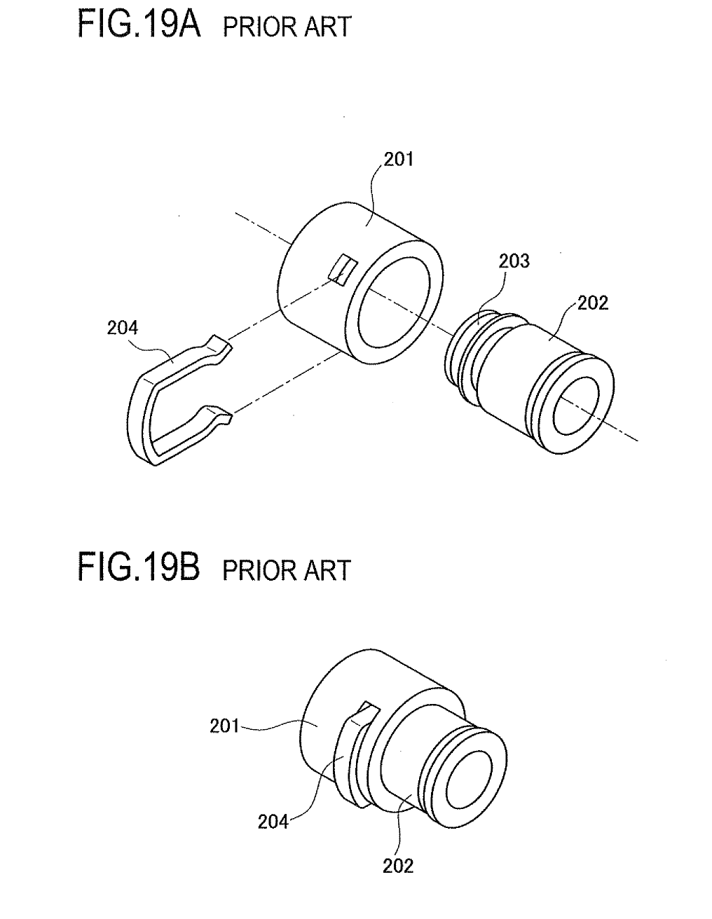

Further, as shown in FIG. 17, the conventional valve 101 and port structure need the joint 112 to connect the tube 111 to the operation port 104 and thus is large in number of parts or components, which leads to an increase in cost. The port structure shown in FIGS. 19A and 19B needs the seal member 203 to seal between the operation port part 201 and the instant joint 202 and further needs the fixing member 204 to fix the instant joint 202 to the operation port part 201. Thus, this port structure using separate members for sealing and fixing the instant joint 202 is large in number of parts or components. On the other hand, the port structure 11 and valve 1 in the present embodiment includes the ferrule 13 serving to prevent disconnection of the tube 111 and also to seal against leakage and therefore is smaller in the number of parts or components than the conventional structure.

In the conventional valve 101 and port structure, furthermore, the joint 112 excepting a part of the male screw 117 protrudes out of the operation port part 104 as indicated by a reference sign W2 in FIG. 17. Thus, the size of the valve and port structure is apt to increase. Recently, downsizing of a semiconductor manufacturing apparatus has advanced, resulting in a decreased clearance provided between devices installed in the semiconductor manufacturing apparatus. Accordingly, when a pipe is to be connected to a main port 102a arranged directly below the operation port part 104 and the air discharge port part 105, for instance, the joints 112 and 122 connected to the operation port part 104 and the air discharge port part 105 respectively are obstructive. On the other hand, in the port structure 11 and valve 1 in the present embodiment, the ferrule 13 is placed in the first operation port part 4, and the nut 12 is screwed into the female screw portion 4a to connect the tube 111 to the first operation port part 4. In this configuration, only the head of the nut 12 slightly protrudes from the first operation port part 4 as indicated by a reference sign W1 in FIG. 5. The same applies to the second operation port part 5. Accordingly, for example, the nut 12 is not obstructive during a piping work to the main port part 2a directly below the first and second operation port parts 4 and 5.

According to the port structure 11 and valve 1 in the present embodiment, the number of parts or components constituting the port structure 11 is small. Consequently, a low-cost and compact port structure 11 can be provided.

In the port structure 11 in the present embodiment, the pressure-receiving surface 13c of the ferrule 13 that contacts with the nut 12 is made of resin (e.g., PTFE) having a lower friction coefficient than the material of the nut 12. It is therefore easy to rotate the nut 12 while the nut 12 presses the ferrule 13. In the port structure 11 in the present embodiment, when the annular protrusion 12d abuts against the shoulder surface 4d of the first operation port part 4, the rotation torque of the nut 12 rises, changing an operation feeling to rotate the nut 12. It is therefore easy for an operator to perceive the completion of a screwing work of the nut 32.

The port structure 11 in the present embodiment enables connection of the tube 111 to the first operation port part 4 by two components, i.e., the ferrule 13 and the nut 12. A component cost is low. Thus, a cost reduction can be achieved.

### Second Embodiment

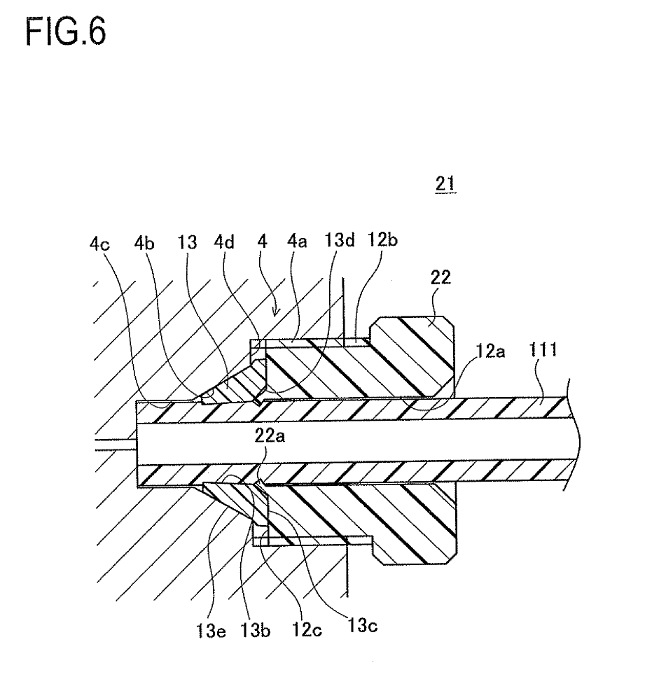

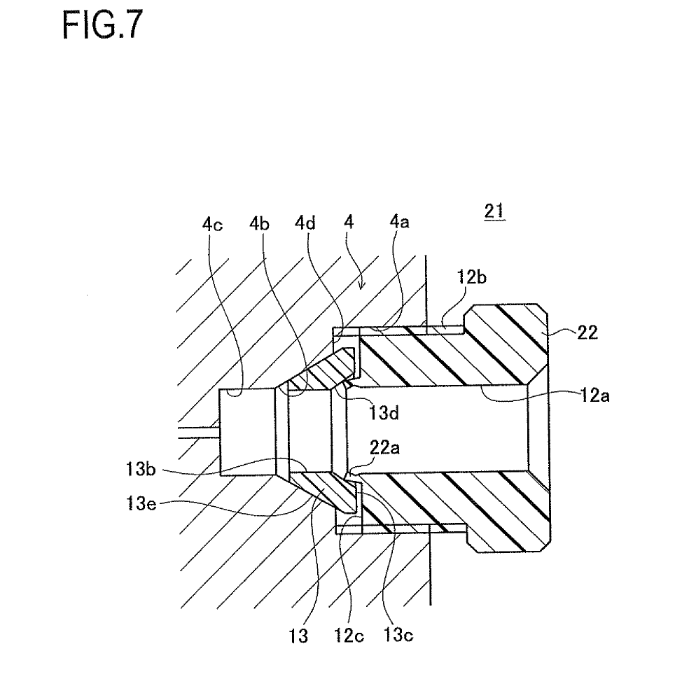

A second embodiment of the present invention will be explained below. FIG. 6 is a cross sectional view of a port structure 21 in this embodiment. FIG. 7 shows a state of the port structure 21 of FIG. 6 before tube connection. In this embodiment, similar or identical parts or components to those in the first embodiment are given the same reference signs and their details are not explained herein.

The port structure 21 in the second embodiment is identical in configuration to the port structure 11 in the first embodiment, excepting that a claw 22a (one example of a protrusion) is provided in a front end face 12c of a nut 22. In the nut 22, the claw 22a has an annular form extending along an opening at a front end of a through hole 12a. The claw 22a is formed to be so thin as to warp inward when pressed by the ferrule 13 and also to protrude in a bending form toward the through hole 12a.

For instance, prior to shipment, as shown in FIG. 7, the ferrule 13 and the nut 22 are attached to a first operation port part 4. At this time, the nut 22 is lightly screwed into the first operation port part 4 without deeply pushing the ferrule 13 inside a tapered hole 4b.

When a tube 111 is to be connected to the first operation port part 4, for example, the tube 111 is inserted in a tube insertion hole 4c of the first operation port part 4 through the through hole 12a of the nut 22 and a through hole 13b of the ferrule 13 and then the nut 22 is screwed in. When the nut 22 is screwed, thereby pressing the claw 22a against a guide part 13d of the ferrule 13, as shown in FIG. 6, the claw 22a is elastically deformed radially inward by receiving a repulsive force from the guide part 13d, and bite into the tube 111. When the nut 22 is further tightened, the front end face 12c of the nut 22 comes into contact with the pressure-receiving surface 13c of the ferrule 13, pushing the ferrule 13 into the tapered hole 4b. Accordingly, the ferrule 13 is elastically deformed as in the first embodiment, preventing disconnection of the tube 111 and providing a seal against leakage.

In the port structure 21 in the second embodiment, disconnection of the tube 111 from the first operation port part 4 is doubly prevented by the claw 22a of the nut 22 and the ferrule 13. As a result, the port structure 21 can more reliably prevent the tube 111 from coming off the first operation port part 4 than in the first embodiment.

### Third Embodiment

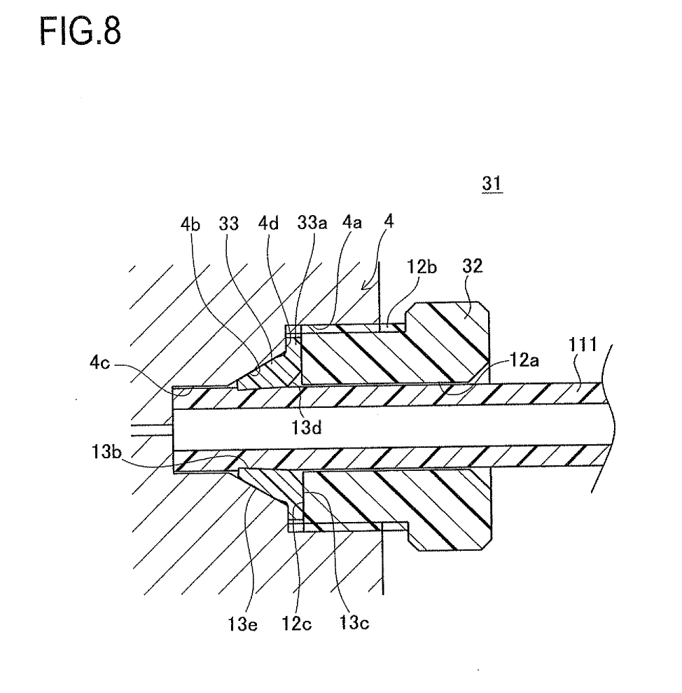

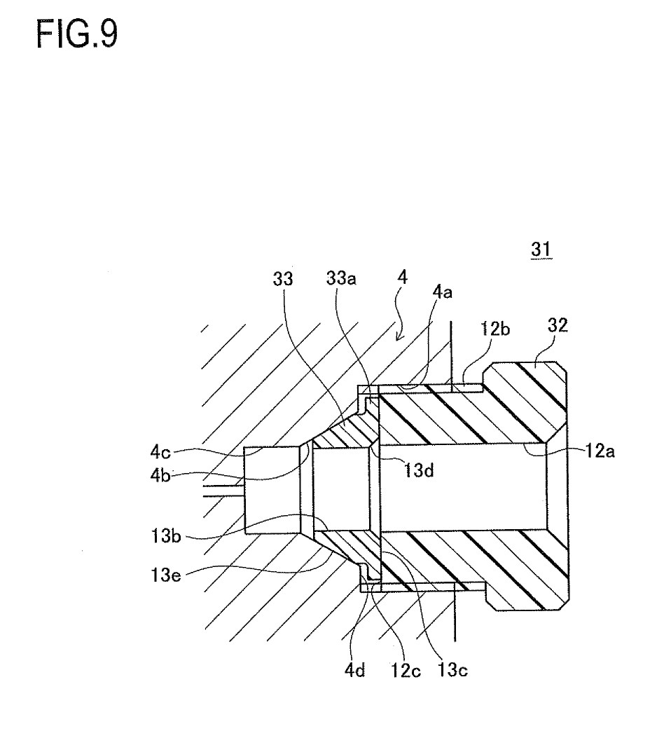

A third embodiment of the present invention will be explained below. FIG. 8 is a cross sectional view of a port structure 31 in this embodiment. FIG. 9 shows a state of the port structure 31 before tube connection. The port structure 31 in this embodiment different from the first embodiment in that a flange 33a of a ferrule 33 is sandwiched between a shoulder surface 4d of a first operation port part 4 and a front end face 12c of a nut 32 to control a screwing amount of the nut 32. In this embodiment, similar or identical parts or components to those in the first embodiment are given the same reference signs and their details are not explained herein.

The front end face 12c of the nut 32 is flat without including the annular protrusion 12d for limiting a screwing amount. On the other hand, the ferrule 33 is formed with the annular flange 33a protruding radially outward from an outer periphery of the rear end. Excepting these points, the nut 32 and the ferrule 33 are similar in configuration to the nut 12 and the ferrule 13 in the first embodiment.

As shown in FIG. 9, at the time of valve shipment, the flange 33a is in contact with the front end face 12c of the nut 32 but out of contact with the shoulder surface 4d.

As shown in FIG. 8, when a tube 111 is inserted in the first operation port part 4 through the nut 32 and the ferrule 33 and then the nut 32 is screwed, the ferrule 33 is pressed by the nut 32 into a tapered hole 4b. Accordingly, a front end portion of the ferrule 33 is deformed radially inward to bite into the tube 111, thereby preventing the tube 111 from coming off.

When the flange 33 comes into contact with the shoulder surface 4d, the ferrule 33 is not allowed to further move. In this way, when the nut 32 is screwed into the port part 4 by an appropriate screwing amount, the rotation torque of the nut 32 rises, changing an operation feeling to rotate the nut 32. It is therefore easy for an operator to perceive the completion of a screwing work of the nut 32. When the flange 33 contacts with the shoulder surface 4d and thus the ferrule 33 no longer moves, the rotation torque of the nut 32 suddenly rises. This enables a user to appropriately tighten the nut 32 into the first operation port part 4 without breaking threads of the nut 32 while perceiving the operation feeling to rotate the nut 32.

According to the port structure 32 in the third embodiment, the ferrule 33 is integrally formed with the flange 3a. With such a simple configuration, the nut 32 can be screwed into the female screw portion 4a appropriately any time without breaking the threads. It is therefore possible to easily control the screwing amount of the nut 32.

### Fourth Embodiment

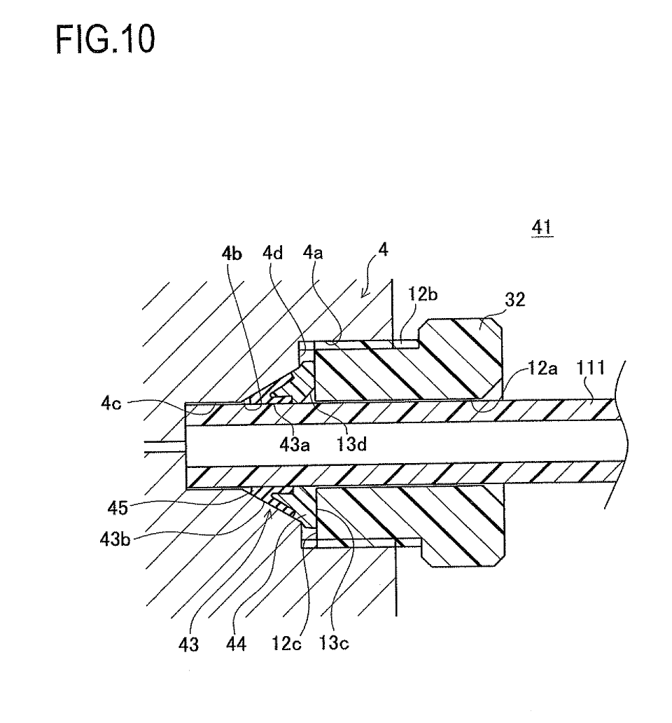

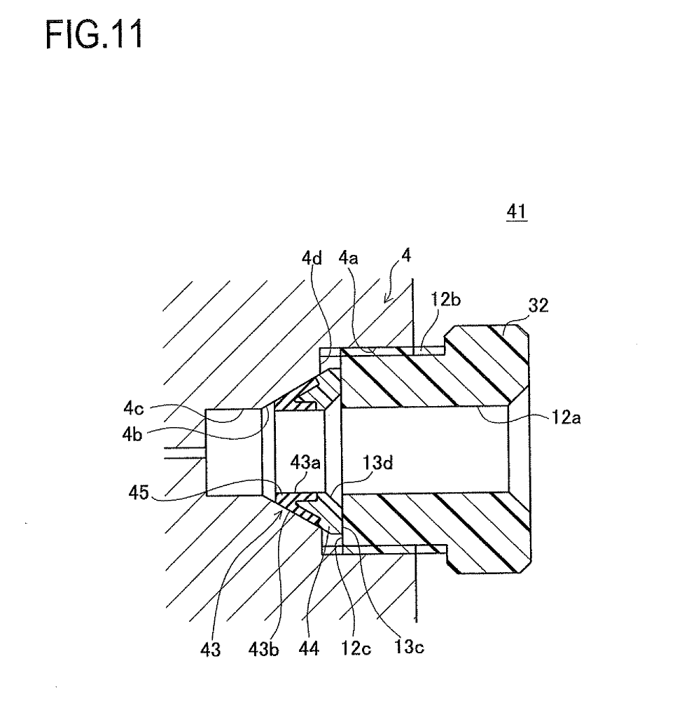

A fourth embodiment of the present invention will be explained below. FIG. 10 is a cross sectional view of a port structure 41 in this embodiment. FIG. 11 shows a state of the port structure 41 of FIG. 10 before tube connection. The port structure 41 in this embodiment is different from the third embodiment in that a rubber seal member 45 is provided to increase a sealing force. In this embodiment, similar or identical parts or components to those in the third embodiment are given the same reference signs and their details are not explained herein.

A ferrule 43 integrally includes the rubber seal member 45 and a resin pressure-receiving member 44. This pressure-receiving member 44 is made of fluorocarbon resin (e.g., PTFE) having a low friction coefficient. The pressure-receiving member 44 is provided with a pressure-receiving surface 13c and a guide part 13d as with the ferrule 13 in the first embodiment. The ferrule 43 also includes a through hole 43a and a tapered surface 43b similar to the through hole 13b and the tapered surface 13e in the first embodiment.

In this port structure 41, prior to shipment, the ferrule 43 is set in a first operation port part 4 so that the seal member 45 contacts with a tapered hole 4b as shown in FIG. 11 and a nut 32 is lightly screwed into a female screw portion 4a.

When a tube 111 is to be connected to the first operation port part 4, as shown in FIG. 10, the nut 32 is screwed into the female screw portion 4a and the ferrule 43 is pushed in the tapered hole 4b, pressing the seal member 45 of the ferrule 43 into close contact with the tube 111.

In this case, the material of the pressure-receiving member 44 is a fluorocarbon resin having a lower friction coefficient than the material of the nut 32. Accordingly, friction resistance occurring between the nut 32 and the pressure-receiving member 44 is small, thus facilitating the rotation of the nut 32.

When the nut 32 is screwed into the female screw portion 4a so as to strongly press the seal member 45 against the tapered hole 4b, the rubber seal member 45 is elastically deformed to provide a seal. Since the seal member 45 has a larger elastic coefficient than the pressure-receiving member 44, it can provide a higher sealing force than in the case where the ferrules 13 and 33 each made of fluorocarbon resin in the first end third embodiments.

Further, the seal member 45 is made of rubber with a higher friction coefficient than the material of the pressure-receiving member 44. Accordingly, in the case where the seal member 45 is pressed in close contact with the tube 111, the tube 111 is less likely to come from or slip off the ferrule 43. In this case, furthermore, the tube 111 is prevented without damage from coming off, so that the reuse factor of the tube 111 is enhanced.

### Fifth Embodiment

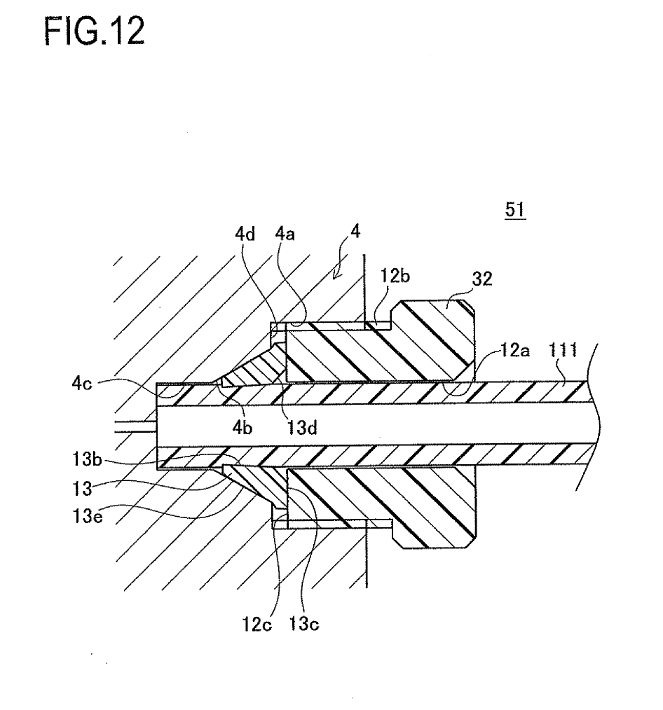

A fifth embodiment of the present invention will be explained below. FIG. 12 is a cross sectional view of a port structure 51 in this embodiment. In this embodiment, similar or identical parts or components to those in the first and third embodiment are given the same reference signs and their details are not explained herein.

The port structure 51 in the fifth embodiment is made by combining the ferrule 13 of the first embodiment and the nut 32 of the third embodiment. The ferrule 13 is pushed in a tapered hole 4b when the pressure-receiving surface 13c is pressed against the front end face 12c of the nut 32, the front end portion of the ferrule 13 is deformed radially inward, biting into a tube 111 to prevent disconnection of the tube 111. The tapered surface 13e of the ferrule 13 is strongly pressed against the inner wall of a tapered hole 4b by the nut 32, providing a seal. Since the ferrule 13 and the nut 32 are simple in shape and low in cost, the port structure 51 can be configured at low cost.

### Sixth Embodiment

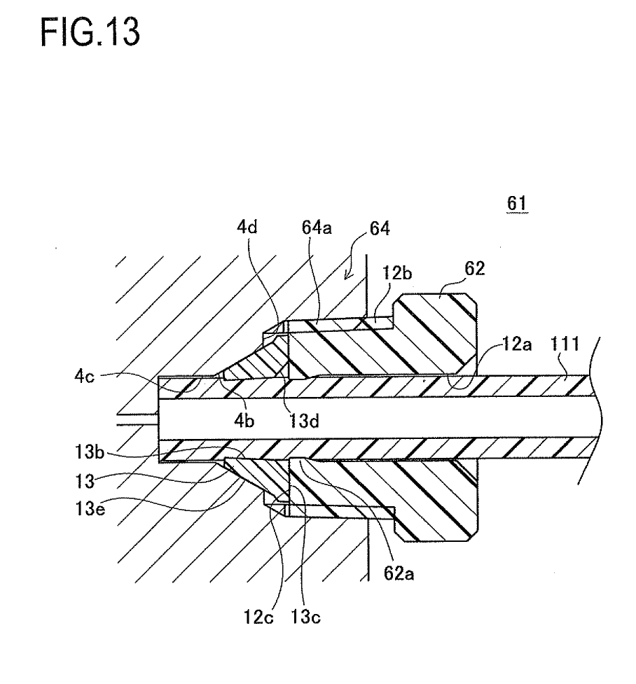

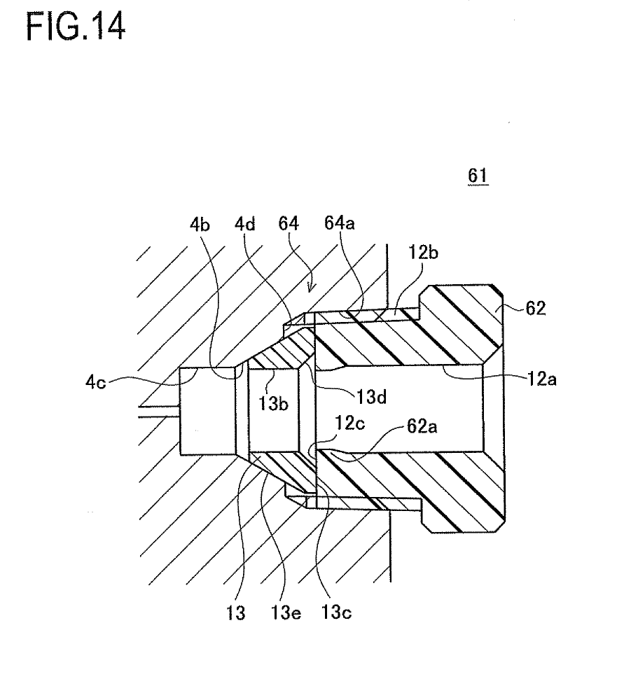

A sixth embodiment of the present invention will be explained below. FIG. 13 is a cross sectional view of a port structure 61 in this embodiment. FIG. 14 shows a state of the port structure 61 of FIG. 13 before tube connection. The port structure 61 in this embodiment is different from the first embodiment in that a female screw portion 64a is used to prevent a tube 111 from coming off. In this embodiment, similar or identical parts or components to those in the first embodiment are given the same reference signs and their details are not explained herein.

A first operation port part 64 is formed with a female screw portion 64a in an inner periphery of an opening portion. The female screw portion 64a includes a taper with a diameter increasing toward an open end of the first operation port part 4.

A nut 62 is provided with a retaining raised portion 62a (one example of a protrusion) protruding into a through hole 12a from an inner periphery of a front opening portion of the through hole 12a.

Prior to shipment, the port structure 61 is arranged such that a ferrule 13 is lightly set in a tapered hole 4b and the nut 62 is lightly screwed into the female screw portion 64a as shown in FIG. 13.

When the tube 111 is to be connected, the tube 111 is inserted in a tube insertion hole 4e through the nut 62 and the ferrule 13, and then the nut 62 is screwed in. When the nut 62 is further tightened, the ferrule 13 is deformed, biting into the tube 111. Further, as the nut 62 is screwed into the female screw portion 64a whose inner diameter becomes smaller toward the insertion hole 4c, the nut 62 receives at its front end portion an inward force from the female screw portion 64a. Accordingly, the retaining raised portion 62a of the nut 62 strongly presses against and bites into the tube 111.

Accordingly, in the port structure 61 in this embodiment, disconnection of the tube 111 is doubly prevented by the ferrule 13 and the nut 62. Thus, the tube 111 can be more reliably prevented from disconnecting from the first operation port part 64.

In the port structure 61 in this embodiment, the retaining raised portion 62a is strongly pressed against the female screw portion 64a. Therefore, disconnection of the tube 111 is more ensured than in the case where the female screw portion 4a having no taper as mentioned in the first embodiment is adopted.

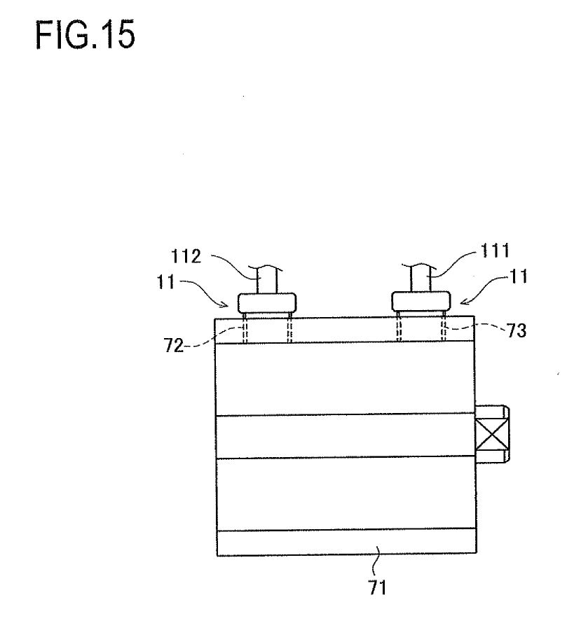

The present invention may be embodied in other specific forms without departing from the essential characteristics thereof. For instance, In the aforementioned embodiments, the port structure 11 is applied to the valve 1 mentioned as one example of a fluid device. As an alternative, as shown in FIG. 15, the port structure 11 may be applied to a first operation port 72 and a second operation port 73 of a cylinder 71 which is another example of the fluid device. As another alternative, the aforementioned port structures 11, 21, 31, 41, 51, and 61 may be applied to port parts of sensors, pumps, fluid control devices, and joints.

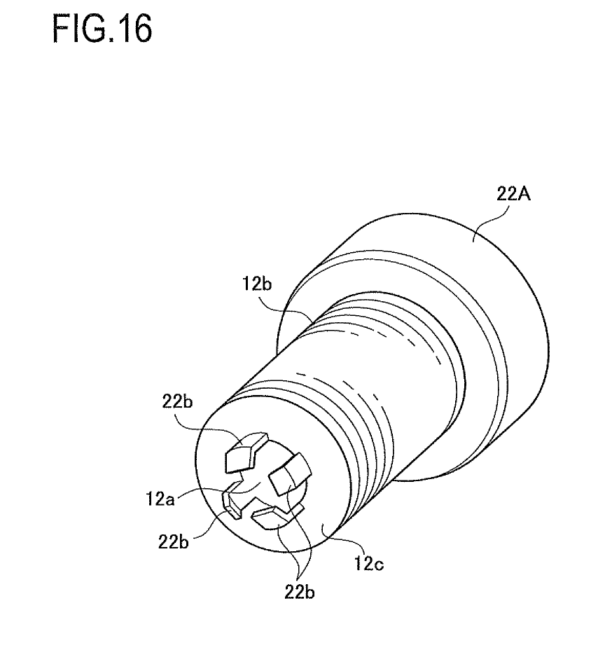

In the second embodiment, the claw 22a has an annular shape. As an alternative, the claw 22a may be divided by one or more slits as shown in FIG. 16 in which a nut 22A is provided with a plurality of claws 22b at circumferentially spaced intervals on a front end face 12c, each claw 22b being elastically deformable in a radial direction. In this case, when the nut 22A is screwed into the port part 4, pressing and deforming the ferrule 13, the claws 22b easily incline radially inward to bite into the tube 111. With this simple configuration, it is possible to easily prevent the tube 111 from coming off.

In the sixth embodiment, for example, the female screw portion 64a has a tapered inner wall surface. As an alternative, the male screw 62b of the nut 62 may be formed with a taper. As another alternative, both the female screw and the male screw may be formed with a taper.

For instance, the female screw 64a in the sixth embodiment may be formed with one or more slits extending in an axial direction in an inner peripheral surface so that the female screw 64a is elastically deformable in a radial direction. In this case, a front end portion of the female screw 64a can made smaller in inner diameter. In the aforementioned embodiments, for instance, the port structures 11, 21, 31, 41, 51, and 61 are applied to a connecting portion of a pipe for operation air. An alternative is to apply the port structures 11, 21, 31, 41, 51, and 61 to a connecting portion of a pipe for another gas such as inert gas or liquid such as water.

In the aforementioned embodiments, the port parts 4, 64, 72, 5, and 73 and the nuts 12, 22, 32, and 62 are made of resin but alternatively made of metal and others.

While the presently preferred embodiment of the present invention has been shown and described, it is to be understood that this disclosure is for the purpose of illustration and that various changes and modifications may be made without departing from the scope of the invention as set forth in the appended claims.

### REFERENCE SIGNS LIST

1: Valve (one example of a fluid device)
4, 64, 72: First operation port part (one example of a port part)
4a: Female screw
4b: Tapered hole
4c: Tube insertion hole
4d: Shoulder surface
5, 73: Second operation port part (one example of the port part)
11, 21, 31, 41, 51, 61: port structure
12, 22, 32, 62: Nut
13, 33, 43: Ferrule
12a: Through hole
12b: Male screw
12d: Annular protrusion
13e: Tapered surface
22a: Claw (one example of a protrusion)
33a: Flange
43b: Tapered surface
44: Pressure receiving member
45: Seal member
62a: Retaining raised portion (one example of the protrusion)
64a: Tapered female screw (one example of a female screw)
71: Cylinder (one example of the fluid device)
111, 121: Tube

1. A port structure for connecting a resin tube to a port part through which a fluid flows in or out, wherein
the port part includes:
a tube insertion hole in which a tube is to be inserted;
a female screw portion provided in an opening of the port part; and
a tapered hole provided on a inward side of the female screw portion and defined by an inner wall surface having a taper with a diameter decreasing from the female screw side to an inward side of the port part,
the port structure comprises:
a nut formed with a through hole in which the tube is inserted and a male screw engaging with the female screw, and
a ferrule made of an elastically deformable material in an annular shape and formed with an outer surface including a tapered surface with a diameter decreasing from a rear end to a front end,
wherein the nut is screwed into the female screw portion to press the ferrule against the inner wall surface of the tapered hole so that the ferrule is elastically deformed radially inward by a repulsive force generated in the inner wall surface of the tapered hole and is pressed against the inner wall surface of the tapered hole to provide a seal.

2. The port structure according to claim 1, wherein the ferrule includes a surface which contacts with the nut, the surface being made of a resin with a smaller friction coefficient than that of a material of the nut.

3. The port structure according to claim 1, wherein the port part includes a shoulder surface between the female screw portion and the tapered hole, and
the nut is formed, on its front end face, with a screwing-amount limiting portion which contacts with the shoulder surface to limit a screwing amount of the nut in the port part.

4. The port structure according to claim 1, wherein the port part includes a shoulder surface between the female screw portion and the tapered hole, and
the ferrule integrally includes a flange protruding radially outward from an outer periphery of the rear end, the flange being to contact with the shoulder surface.

5. The port structure according to claim 1, wherein the nut is provided, at its front end, with a protrusion protruding into the through hole.

6. The port structure according to claim 1, wherein the female screw portion includes a taper with a diameter decreasing toward the tapered hole side.

7. The port structure according to claim 1, wherein the ferrule integrally includes a pressure-receiving member which contacts with the nut and a seal member which is pressed against the tapered hole to provide a seal, and
the pressure-receiving member is made of a resin smaller in friction coefficient than that of a material of the nut, and the seal member is made of rubber.

8. A fluid device placed in a flow path for flowing a fluid, comprising a port structure including:
a port part to which a resin tube is connected to allow air or inert gas to flow in or out, the port part including:
a tube insertion hole in which a tube is to be inserted;
a female screw portion provided in an opening of the port part; and
a tapered hole provided between the tube insertion hole and the female screw portion and defined by an inner wall surface having a taper with a diameter decreasing from the female screw side toward the tube insertion hole side,
a nut formed with a through hole in which the tube is to be inserted and a male screw engaging with the female screw portion; and
a ferrule made of an elastically deformable material in an annular form and formed with an outer surface including a tapered surface with a diameter decreasing a rear end to a front end,
wherein the nut is screwed into the female screw portion to press the ferrule against the inner wall surface of the tapered hole so that the ferrule is elastically deformed radially inward by a repulsive force generated in the inner wall surface of the tapered hole and is pressed against the inner wall surface of the tapered hole to provide a seal.
